(19) United States
(12) Patent Application Publication
(10) Pub. No.: US 2018/0192454 A1
(43) Pub. Date: Jul. 5, 2018

(54) NETWORKING CORE DEVICE, WIRELESS NETWORKING METHOD, AND INTELLIGENT NETWORK SYSTEM, BASED ON ELECTRONIC MODULE

(71) Applicants: Microduino Inc., Westlake Village, CA (US); Meike Technology (Beijing) Ltd., Beijing (CN)

(72) Inventors: Kejia PAN, Beijing (CN); Yang SHEN, Beijing (CN); Zhenshan WANG, Beijing (CN); Bin FENG, Westlake Village, CA (US)

(21) Appl. No.: 15/859,914

(22) Filed: Jan. 2, 2018

(30) Foreign Application Priority Data
Jan. 2, 2017 (CN) 201710000207.2

(51) Int. Cl. H04W 76/10; H04L 12/24

(52) U.S. Cl. CPC H04W 76/10; H04W 84/18; H04L 41/12

(57) ABSTRACT

A networking core device, a wireless networking method and an intelligent network system, based on an electronic module are provided. The networking core device includes a function-module processor configured to identify and control at least one functional electronic module electrically connected to the networking core device; an in-group networking member configured to establish a wireless connection between the networking core device and at least one other networking core device based on a first communication protocol; and a controller configured to establish a connection between the networking core device and an intelligent terminal based on a second communication protocol, and receive and process a control signal of the intelligent terminal.

### CROSS-REFERENCES TO RELATED APPLICATIONS

This application claims the priority of Chinese patent application No. CN201710000207.2, filed on Jan. 2, 2017, the entire content of which is incorporated herein by reference.

### FIELD OF THE DISCLOSURE

The present disclosure relates to the field of electronics and, more particularly, relates to a networking core device for an electronic module, a wireless networking method and an intelligent network system based on electronic module(s).

### BACKGROUND

Technical devices are widely used today in the daily life of children and adults. However, most people do not know the working modes of these devices nor know how to assemble and construct their intended devices. In fact, there is a great difference between the knowledge mastered by a common person and the knowledge involved with this person's usage and consumption devices. Therefore, ordinary people cannot design or construct electronic equipment. At present, components that are commercially available in the market have different specifications, and components with different functions may not be matched with each other. In addition, the common connection mode between the electronic modules which can be matched with each other is specific, and the expansion ability is limited. Further, if a plurality of electronic modules are designed to work at different physical positions in a collaborative mode, the complicated programming of each electronic module is required to achieve this purpose. It is not convenient to ordinary people to build up the electronic system.

### BRIEF SUMMARY OF THE DISCLOSURE

One aspect of the present disclosure provides a networking core device. The networking core device includes a function-module processor, an in-group networking member, and a controller. The function-module processor is configured to identify and control at least one functional electronic module electrically connected to the networking core device. The in-group networking member is configured to establish a wireless connection between the networking core device and at least one other networking core device based on a first communication protocol. After establishing the wireless connection, the in-group networking member is configured to communicate with the at least one other networking core device. The networking core device and the at least one other networking core device form a wireless network based on the first communication protocol, and each networking core device is a node of the wireless network. The controller is configured to establish a connection between the networking core device and an intelligent terminal based on a second communication protocol, and receive and process a control signal of the intelligent terminal.

Another aspect of the present disclosure provides a wireless networking method. A first networking device and at least one functional electronic module are electrically connected to form a first system. A wireless connection is established between the first networking core device and at least one second networking core device based on a first communication protocol to form a first network. Each networking core device in the first network is a node, and the first networking core device acquires a node information of each node in the first network. The first system and an intelligent terminal are connected based on a second communication protocol. The node information of each node in the first network is sent by the first system to the intelligent terminal through a connection path between the intelligent terminal and the first networking core device established based on the second communication protocol. A control instruction of each node in the first network sent by the intelligent terminal is received by the first system. The control instruction is sent by the first system to a corresponding node through the first network.

A further aspect of the present disclosure provides an intelligent network system based on an electronic module. The intelligent network system includes at least two networking core devices, and at least two functional electronic modules. Each networking core device is configured to identify and control the functional electronic module electrically connected to the networking core device; establish a wireless connection between the networking core device and at least one other networking core device based on a first communication protocol to form a first network, where each networking core device in the first network is a node; and acquire a node information of each node in the first network. The at least two networking core devices include a first networking core device, the at least two functional electronic modules include a first functional electronic module, and the first networking core device is electrically connected to the first functional electronic module to form a first system. The first system is connected to an intelligent terminal based on a second communication protocol. The first system sends the node information of each node in the first network to the intelligent terminal through a connection path between the intelligent terminal and the first networking core device established based on the second communication protocol. The first system receives a control instruction of each node in the first network sent by the intelligent terminal. The first system sends the control instruction to a corresponding node through the first network.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a structural block diagram of an exemplary networking core device consistent with various disclosed embodiments;

FIG. 2 illustrates another structural block diagram of an exemplary networking core device consistent with various disclosed embodiments;

FIG. 3 illustrates a functional diagram of an exemplary networking core device consistent with various disclosed embodiments;

FIG. 4 illustrates a flow chart of an exemplary wireless networking method consistent with various disclosed embodiments;

FIG. 5 illustrates a networking structure diagram of an exemplary wireless networking consistent with various disclosed embodiments;

FIG. 6 illustrates a structural block diagram of an exemplary intelligent network system based on an electronic module consistent with various disclosed embodiments;

FIG. 7 illustrates a flow chart of a demonstration of an exemplary intelligent network system based on an electronic module consistent with various disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

The technical problem to be solved by the present application is that ordinary people cannot conveniently design or construct electronic equipment, and cannot conveniently establish the wireless network for communication and cooperative work between electronic modules. Therefore, the first objective of the present application is to provide a networking core device for the electronic module, the second objective of the present application is to provide a wireless networking method, and the third objective of the present application is to provide an intelligent network system based on an electronic module, which is easy to operate and construct.

The present application provides a functional electronic module that may be used by adults and children without the requirement of various complex knowledge of advanced electronic equipment or being a programming expert. The children or adults may create an exclusive interactive toy, an object, or a customized interactive product. Meanwhile, the children or adults need not be programmed experts and do not have to learn a lot of complex knowledge related to these advanced electronic apparatus. The functional electronic module may be used to establish an intelligent network system based on the electronic module. The intelligent network system may be used to complete a remote internet-of-things system capable of being defined by the users.

The present application provides a networking core device for establishing a wireless networking of an electronic module, a wireless networking method, and an intelligent network system based on an electronic module. The electronic module in the present application may be also named a module or an electronic building block. The networking core device in the present application may be also named a networking electronic module or a core electronic module.

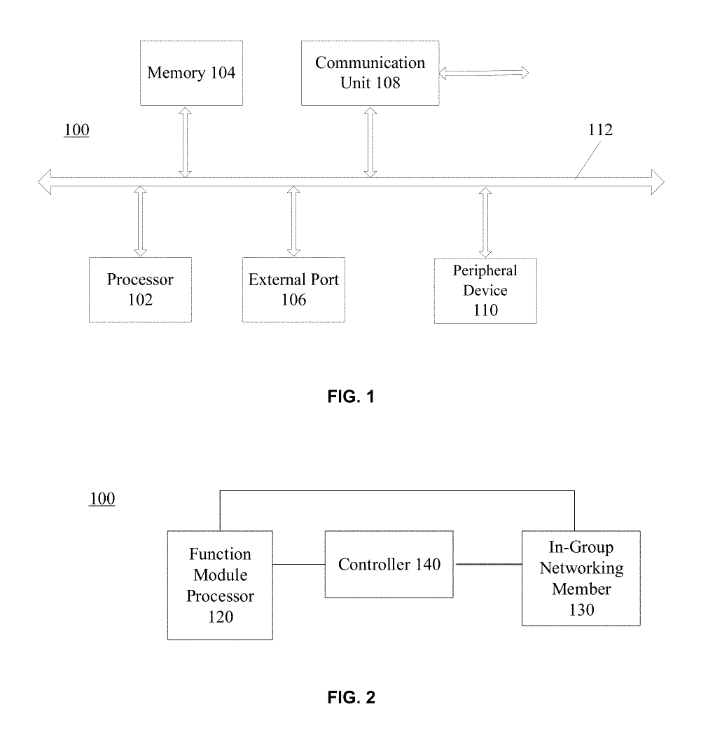

Please refer to FIG. 1 which illustrates a structural block diagram of an exemplary networking core device consistent with various disclosed embodiments. As shown in FIG. 1, the networking core device 100 may include a processor 102, a memory 104, an external port 106, a communication unit 108, a peripheral device 110, and bus 112 connecting these components together.

It should be noted that the networking core device 100 is only one example of a networking core device. The networking core device 100 may have more than or less than the illustrated components, may have one or more same illustrated components, two or more illustrated components may be combined or be arranged in different configurations, or different arrangement can be carried out on the illustrated components. The various components in FIG. 1 can be implemented by hardware, software, or a combination of hardware and software, including one or more signal processing and/or application integrated circuits. In some embodiments, the processor 102, the memory 104, the external port 106, the communication unit 108 and the bus 112 may be implemented in a single chip. In other embodiments, they may be implemented respectively by independent chips.

The memory 104 may be used to store software programs. The processor 102 executes various functional applications and data processing by running a software program stored in the memory 104, for example, identifying and controlling a function module connected to the external port, analyzing a networking information received by the communication unit, and establishing a mesh network with the other networking core device. In addition, the memory 104 may include a high-speed random access memory, and may also include a non-volatile memory, such as at least one magnetic disk storage device, a flash memory device, or other volatile solid state memory devices. Further, the memory 104 may also include a memory controller to provide access to the memory 104 by the processor 102 and the external port 106.

The communication unit 108 is configured to receive and transmit electromagnetic waves, so that the mutual conversion between the electromagnetic wave and the electric signal is realized to communicate with a communication network or other equipment. The communication unit 108 may include various conventional circuit elements for performing these functions, such as, an antenna, a radio frequency transceiver, a digital signal processor, an encryption/decryption chip, and a memory. The communication unit 108 may communicate with various networks or communicate with other devices through a wireless network. The communication unit 108 may support one or more communication standards, protocols, and techniques, including but not limited to Infrared, Bluetooth, wireless personal area network (WPAN) standard, WiFi, Voice over internet protocol (VoIP), Worldwide Interoperability for Microwave Access (Wi-Max) and any other suitable communication protocol, and even the protocols which are not currently developed.

The external port 106 may include a hardware interface, which may be a data port or a signal port. When one function module is connected to the bus 112 of the networking core device 100 through the matched external port 106, the networking core device 100 may perform data information exchange with the connected function module through the bus 112. In general, different function modules are provided with the same peripheral hardware interface and are matched with the external port 106 of the networking core device 100. The function module, may be also named function electronic module or specific function electronic module, may include the display module, the media playing module, the motor driving module, the sensing module (such as temperature, humidity, illumination, air quality, human body, color recognition, proximity, collision, attitude, heart rate, gesture, touching, or ultrasonic sensing modules), the communication module, the voice acquisition module and the image acquisition module. One function module may achieve a single function or may integrate multiple functions.

The peripheral device 110 may include input or output devices, such as indicating lamps, switches, speakers, and the like. The peripheral device 110 may be used for indicating the working state of the networking core device 100 or controlling the working mode of the networking core device 100. For example, when detecting that the connection is abnormal, the networking core device 100 may give out a warning through the indicating lamp and the speaker. The networking core device 100 may also be provided with a reset button for restoring default setting, or a networking enable button for enabling the networking function to organize or join the network.

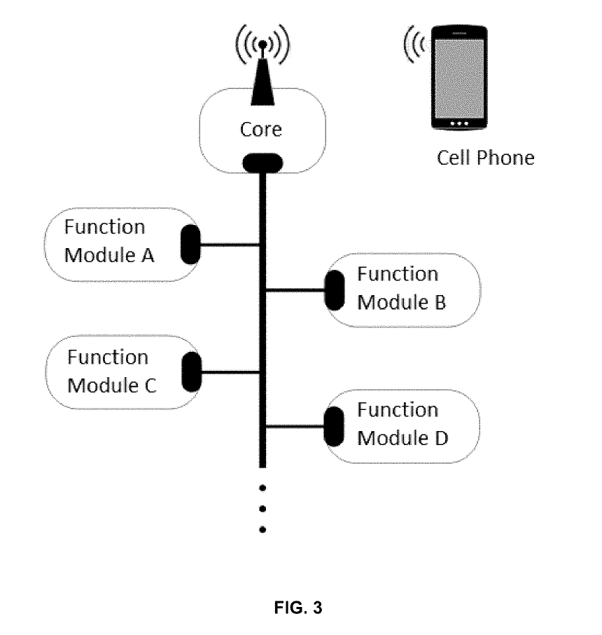

FIG. 2 illustrates another structural block diagram of an exemplary networking core device consistent with various disclosed embodiments. FIG. 3 illustrates a functional diagram of an exemplary networking core device consistent with various disclosed embodiments. The core in FIG. 3 illustrates the networking core device of the present application.

As shown in FIG. 2 and FIG. 3, the networking core device 100 may be used for realizing three different connections and information exchange, such as the connection and exchange with one or more function modules, the connection and exchange with one or more in-group networking core devices, and the connection and exchange with the intelligent terminal (such as a mobile phone and the like). These three kinds of connection and exchange may be online simultaneously or independently. Based on this, the structure of the networking core device 100 may include a function-module processor 120, an in-group networking member 130 and a controller 140.

The function-module processor 120 may be used for identifying and controlling a connected function module. The networking core device 100 and the function module may be electrically connected through an external port 106. In some embodiments, the networking core device and all the function modules adopt a unified interface, and the networking core device 100 may use one bus to organize one or more function modules. After the connection is successful, the function-module processor 120 may automatically recognize all the function modules hung on the bus, and a unique communication address is distributed to each function module. Then all function modules may be controlled by adopting a proper communication rate according to the load rate on the bus.

For example, each specific function module may be internally provided with a unique physical address, and the physical address includes the module model code and the equipment code (similar to the serial number). The function-module processor 120 may recognize the module types according to the model codes, and manage the bus addresses through the equipment codes. The communication content between the function-module processor 120 and one successfully connected function module may include: inquiring the working state of the function module and obtaining the feedback, receiving the output data of the function module (such as the data collected by the function module of the sensors, or the data received by the WiFi module from the wireless network), and sending data or instructions to the function module for execution (such as playing music or starting a motor).

When two function modules are simultaneously connected to the networking core device 100, the function-module processor 120 may also be used for forwarding information of one of the function modules to another function module. Further, in a normal working state, if the function module is abnormal or disconnected, the function-module processor 120 may detect and indicate the system abnormity.

The function-module processor 120 may generate and obtain data information of a function module connected thereto. The data information may include: the number or type of the function module, the communication address of each function module in a bus, and signals related to specific functions of the function modules (such as running parameters, collected data and the like). The function processing unit 120 may further control the connected function modules according to the received instruction.

As shown in FIG. 3, the networking core device may be electrically connected with a plurality of function modules (function modules A, B, C and D) through a bus. The function modules A, B, C and D may be modules with four different functions, or all or partial modules may be modules with the same functions. In the present application, when one networking core device and one or more function modules are successfully connected, the combination may also be called as a system.

The in-group networking member 130 may be used for establishing wireless connection with at least one networking core device based on a first communication protocol. After the wireless connection is successfully established, the data communication transmission is carried out between the in-group networking member 130 and at least one networking core device. The in-group networking member 130 may discover another networking core device within its communication distance, and establish a network connection with the networking core device. In some embodiments, the first communication protocol supported by the in-group networking member 130 may be a wireless personal area network (WPAN) protocol, such as 6LoWPAN (IPv6 over Low Power Wireless Personal Area Networks) based on the IEEE 802.15.4 standard.

In a default configuration, the user may enable the wireless networking function of the in-group networking member 130 through a physical key or other function module on the networking core device 100. The networking core devices under the default configuration may be mutually found at the communication distances, and the networking is automatically set. The automatically setting networking may discover available devices nearby (other networking core devices which can be connected), and establish connection between the networking core devices. In the present application, the wireless network established based on the first communication protocol between a plurality of networking core devices (through the respective in-group networking members 130) may also be referred to as a first network.

One networking core device in the first network may also be referred to as a node. When the networking core device is connected with the function module and the first network, the networking core device may be referred to as a system node. After the first network is established, each networking core device may obtain relevant information of any system node in the first network, such as the networking configuration information or the data information of the function module. In other words, an in-group networking member 130 of a networking core device may obtain data information of a function module connected with the networking core device from the function-module processor 120, and may maintain its network configuration information. The data information and the network configuration information may be received by another networking core device in the first network.

The controller 140 may be used for performing information exchange with the intelligent terminal, including sending the state information of the networking core device to the intelligent terminal, and receiving and responding the configuration information sent by the intelligent terminal. The state information may include: the relevant information of all the function modules which are currently connected with the networking core device, and networking configuration information of the networking core device based on the first communication protocol.

When the networking core device 100 has established wireless connection with other networking core devices, namely one node of the first network, the state information may further include the network information, namely information of all other nodes in the first network, such as the relevant information of a connected function module of another networking core device in the first network, and the network configuration information based on the first communication protocol (such as node identifiers and communication addresses).

Further, the controller 140 may be configured to, according to the configuration information of the intelligent terminal, control a connected function module (through a function-module processor 120, and may be configured to set up a communication rules and/or a collaborative logic rule used by the networking core device and other networking core devices (through the in-group networking member 130).

In some embodiments, the controller 140 may be further used for establishing connection with the intelligent terminal based on a second communication protocol. The second communication protocol may support the bluetooth protocol, then infrared transmission protocol, the WiFi transmission protocol and the like. The second communication protocol may be a communication protocol used by a developer to carry out deep processing based on the WiFi communication, the bluetooth communication and the infrared communication. The state information and the configuration information may be transmitted through the connection based on the second communication protocol.

As shown in FIG. 3, the networking core device may establish connection with a mobile phone through the second communication protocol to transmit data. In other embodiments, the controller 140 may perform the information exchange with the intelligent terminal through the in-group networking member 130. For example, a connection is established between the other node in the first network where the networking core device 100 is located and the intelligent terminal based on the second communication protocol, and the node can forward the exchanged information between the networking core device 100 and the intelligent terminal.

In some embodiments, when the controller 140 receives and responds to the configuration information sent by the intelligent terminal, the controller 140 may disconnect the connection with the intelligent terminal. Each node in the first network may achieve the configured function through the connection of the first network according to the configured information.

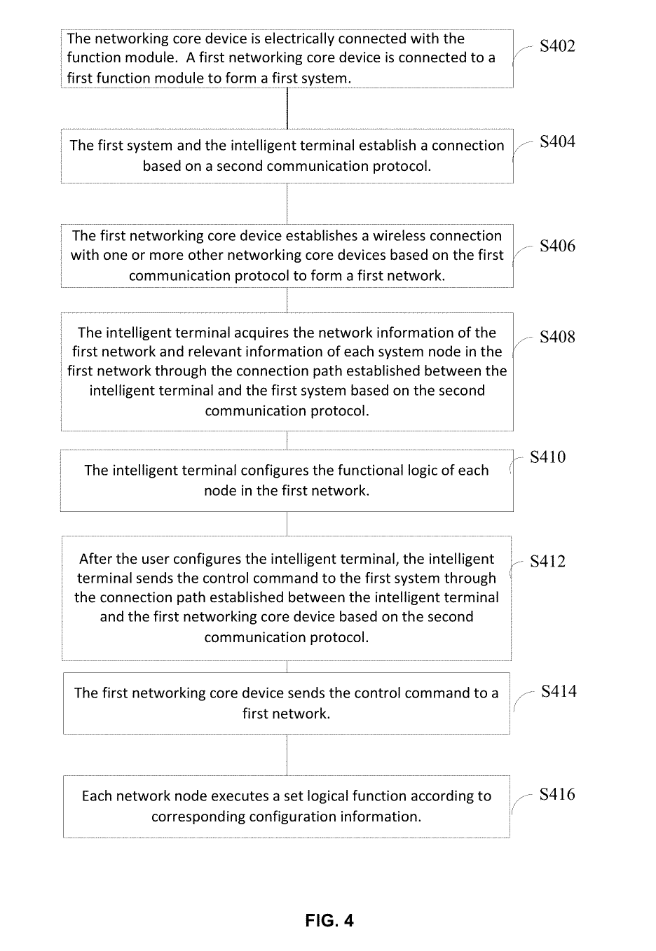

FIG. 4 illustrates a flow chart of an exemplary wireless networking method consistent with various disclosed embodiments. The wireless networking method provided by the present application may be completed by the combination of two or more networking core devices, two or more function modules, and an intelligent terminal. As shown in FIG. 4, the wireless networking method may include the following steps.

The networking core device is electrically connected with the function module (S402). A first networking core device is connected to a first function module to form a first system, and a second networking core device is connected to a second function module to form a second system. For example, the user may connect the function module A with an external port of the networking core device 1.

After the connection is successful, the networking core device 1 automatically recognizes the function module A through the bus, assigns a unique communication address to the function module A, and controls the function module A through the bus. The function module B is also connected with the networking core device 1 in the similar manner. The networking core device 1 and the function modules A and B form a system 1. The function module C may be connected with the networking core device 2, and form the system 2. The system 1 and the system 2 may be arranged at different physical positions.

The first system and the intelligent terminal establish a connection based on a second communication protocol (S404). For example, the second communication protocol may support the bluetooth connection protocol, and may also be a communication protocol used by a developer based on WiFi communication, bluetooth communication and infrared communication. By taking bluetooth as an example, the first networking core device and the intelligent terminal may be located in a bluetooth communication distance.

The intelligent terminal may be installed the matched application programs. When the user selects starting the configuration function of the application program on the intelligent terminal, the intelligent terminal may turn on the bluetooth and the equipment in the bluetooth communication distance may be automatically discovered. The intelligent terminal performs the bluetooth matching with the first networking core device, and after the pairing is successful, the application program of the intelligent terminal may send a request for obtaining state information to the first networking core device.

The second communication protocol may be an internet network. The first system may include a function module (such as a WiFi function module) which may be connected to an internet cloud server. The intelligent terminal may log in the cloud server, and then the connection between a WiFi function module (namely a first system) and the intelligent terminal is established based on the second communication protocol.

The first networking core device establishes a wireless connection with one or more other networking core devices based on the first communication protocol to form a first network (S406). The wireless connection may be established between the first networking core device and the second networking core device based on the first communication protocol.

In some embodiments, if the first networking core device and the second networking core device are located in the communication distance of each other, the first networking core device may automatically discover the second networking core device and automatically establish connection based on the first communication protocol. If the first networking core device and the second networking core device are not in communication distances of each other, but both are located in the communication distance of the third networking core device, the first networking core device and the second networking core device may be automatically connected through the third networking core device based on the first communication protocol.

This step may be performed before, between or after steps S402 and S404. As long as the self-networking function of the networking core device is turned on, under the default mode, the networking core devices in the communication distance may be discovered automatically by each other to form the first network. The first network may be a mesh network. In some embodiments, the default settings of the first networking core device may be modified, and the first networking core device and the second networking core device may not be discovered by each other in the communication distance. In this case, the intelligent terminal may establish the connection with the first networking core device through the Bluetooth. The intelligent terminal may modify the network configuration of the first networking core device and restart the self-networking function of the first networking core device.

The intelligent terminal may use the above steps to modify the network configuration information of at least one of the first networking core device and the second networking core device. After the modification is completed, the first networking core device and the second networking core device may be connected based on the first communication protocol to form the first network.

After the first network is established, each networking core devices may obtain relevant information of any system node in the first network, such as the network configuration information or the data information of the function module. In other words, the networking core device may maintain the data information of the function module connected with itself and its network configuration information. The data information and the network configuration information may be received by any one networking core device in the first network.

Steps S402, S404 and S406 are not limited in sequence. In some embodiments, such as after the first network is established, the first function module and the first networking core device is electrically connected then.

The intelligent terminal acquires the network information of the first network and relevant information of each system node in the first network through the connection path established between the intelligent terminal and the first system based on the second communication protocol (S408). In some embodiments, the intelligent terminal may receive the state information of the first networking core device through bluetooth transmission.

In other embodiments, the WiFi function module of the first system may forward the state information of the first networking core device to the intelligent terminal through the internet. The state information of the first networking core device may include: the relevant information of the first networking core device and all the function modules electrically connected to the first networking core device, the networking configuration information of the first networking core device based on the first communication protocol, and the information of all other nodes in the first network. In other words, the first networking core device and the second networking core device establish a connection path based on the first communication protocol, and the first networking core device may receive relevant information of the second system, where the relevant information includes the information of the function module connected with the second networking core device and the networking configuration information of the second networking core device based on the first communication protocol.

A further connection path is established between the intelligent terminal and the first networking core device based on the second communication protocol, and the first networking core device may send the received relevant information of the second system to the intelligent terminal. In other words, the first system may send the node information of each node in the first network to the intelligent terminal.

The intelligent terminal configures the functional logic of each node in the first network (S410), which includes configures the functional logic of the first system and the second system. An application of the intelligent terminal may provide a graphical user interface (GUI) for configuring networks and functions. Specifically, each node in the first network may be displayed on the interface, and the function of each node may be completed (the type of the function module contained in the node) may be also displayed. The user may perform network configuration and/or function setting on each node through the intelligent terminal. Each node in the first network may have a unique identifier (such as a network address), and the intelligent terminal may generate configuration information corresponding to the node identifier according to the setting instruction of the user.

In some embodiments, the intelligent terminal may view and modify network configuration based on a first communication protocol of the networking core device on each node. For example, five system nodes exist in the first network, the intelligent terminal may specify three nodes as a set of system, the rest two nodes are another set of systems, and the two groups cannot be found from each other.

In some embodiments, the intelligent terminal may check and set operation coordination logic of the function module on each system node. The operational coordination logic may include conditional logic. For example, when the first function module of the first system is set to meet the set conditions, the first networking core device sends a trigger signal to the second networking core device through the first network, and the second networking core device is set to control the second function module to execute a function after receiving the trigger signal. The operation coordination logic may also include AND or other logics. For example, when the first function module of the first system meets one of any two set conditions, triggering a second function module of the second system to execute a function.

After the user configures the intelligent terminal, the intelligent terminal generates a control command according to the configuration, and the intelligent terminal sends the control command to the first system through the connection path established between the intelligent terminal and the first networking core device based on the second communication protocol (S412). The control command may include a node identifier and configuration information of a corresponding node. The configuration information of one system node may include the operation parameter configuration information of the function module of the system node and the networking configuration information of the system node based on the first communication protocol.

The first networking core device sends the control command to a first network (S414). This step may include that the first networking core device identifies the first node identifier corresponding to the first networking core device and reads the corresponding first configuration information; and the first networking core device sends the second configuration information to a second networking core device corresponding to the second node identifier. In some embodiments, after the step s412 is completed, the intelligent terminal may disconnect the connection with the first networking core device based on the second communication protocol. Each network node may automatically run the set function according to the configuration information.

Each network node executes a set logical function according to corresponding configuration information (S416). The first networking core device may process and modify the setting and operation of the first system according to the first configuration information, and the second networking core device may process and modify the setting and operation of the second system according to the second configuration information. For example, if the network configuration of one node is modified, the networking core device of the node may be operated according to a new network configuration after the modification is completed; and if the function of the function module of one node is set, the networking core device of the node may control the function module to be operated according to the configuration information.

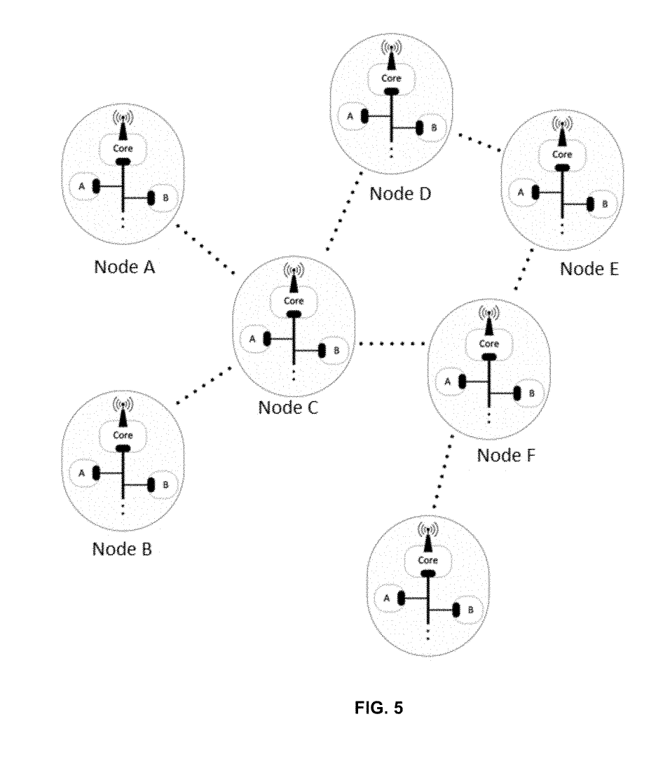

FIG. 5 illustrates a networking structure diagram of an exemplary wireless networking consistent with various disclosed embodiments. The network structure shown in FIG. 5 may be the structure of the first network based on the first communication protocol formed after the steps 402 and 406. The first communication protocol may be a wireless personal area network (WPAN) protocol. The first communication protocol may be a developer protocol standard based on WiFi communication, BLUETOOTH communication and Infrared communication.

Each system node in FIG. 5 includes a networking core device (Core) and at least one function module connected to a bus of the networking core device. The function modules A and B in the system nodes shown in FIG. 5 may represent function modules with different functions or configurations. For example, the function module A of the node A and the function module A of the node C can be completely different function modules.

In addition, each of the illustrated system nodes includes two function modules in the embodiment, but each system node may contain different numbers of function modules according to the application scene. When the networking function of the networking core device is in an ON state, and the networking core devices in the communication distance may be automatically found out, a plurality of system nodes may be automatically combined into a wireless mesh network.

The network structure provided by the present disclosure may achieve addressing communication of a system node to another system node, and the system nodes may be freely combined and expanded without a gateway or a one-to-one or multiple-to-one router. For example, a system node A and a system node G is not in a mutual communication distance, and according to the addressing communication, the system node A may realize connection and data transmission with the system node G through the system nodes C and F. For another example, if the system node H is newly found in the communication distance of the system node B, the system node H and the system node B may be automatically found each other, and the system node H may be added into the wireless network.

The wireless network may include an organizer (Leader). For example, when the wireless network is established, the second networking core device may serve as an organizer to maintain the whole network. The first networking core device may be used as a router eligible end device to join the network. The organizer may determine whether to use a certain networking core device as a route to connect other networking core devices in the network according to the network condition. For example, node C may be the organizer, node C itself also has a routing function, and node C may also decide to enable node F's routing function. Node G's (child node) routing function is not enabled, and may communicate with other nodes through node F (parent node). Each router is informed of the status of other routes by the Trickle mechanism and MLE (mesh link establishment).

In a wireless network based on the first communication protocol, the network function may be completed without a specific networking core device, and the method has no single-point fault capability. For example, if a fault occurs in one routing node, the network sends the dynamic direction to the sending transmission and bypasses the fault node. For another example, if the current organizer is disconnected, the other node device with the routing function may be referred to as a new organizer to make a decision in the network. When the node is added to the network and the topological structure changes, the network is adjusted by exchanging the MLE (mesh link establishment) message. When needed, according to the network condition, the organizer may enable or close the routing function of a certain node to optimize the network connection. The node equipment with the routing function in the network may also listen to routing information, and when the overall performance of the network needs to be improved, the node equipment is applied to the organizer as a router in the network.

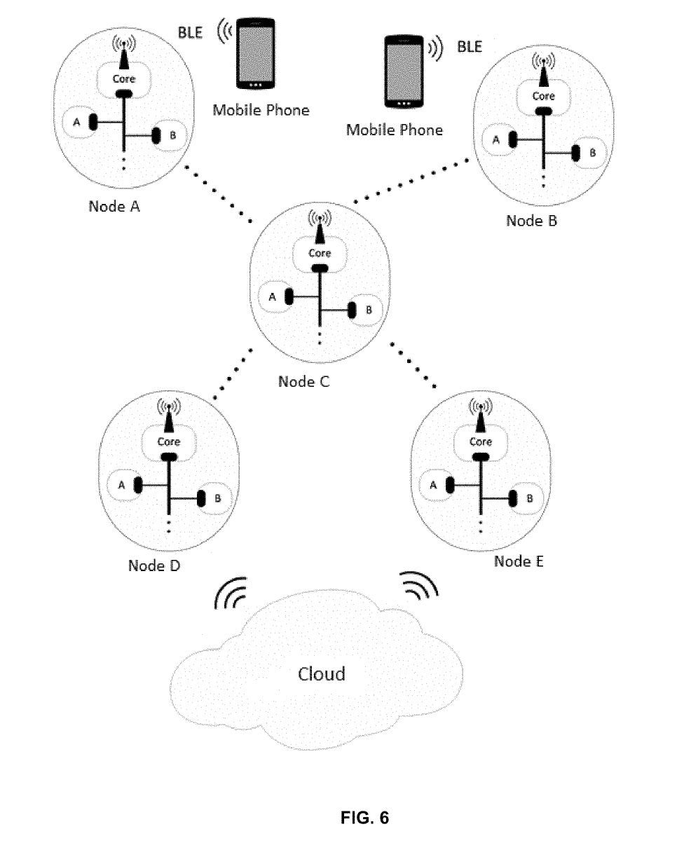

FIG. 6 illustrates a structural block diagram of an exemplary intelligent network system based on an electronic module consistent with various disclosed embodiments. The intelligent network system provided by the present disclosure may include two or more networking core devices and two or more function modules. In the embodiment shown in FIG. 6, the two or more function modules include a WiFi function module. The WiFi function module may be a function module A connected with a networking core device of the node E.

The intelligent network system may be established based on the wireless networking method described above (steps S402-S414). Specifically, the core of nodes A to E may be wireless connected based on the first communication protocol, and the first network is established thereafter. The networking core device of the node A may be connected with an intelligent terminal (such as a mobile phone) based on a second communication protocol (such as BLUETOOTH or a developer protocol standard based on WiFi communication, BLUETOOTH communication and infrared communication). Each node in the first network may be configured by the intelligent terminal, and a networking relationship between the system node and other system nodes may be included to control the functions of the system node and other system nodes.

In some embodiments, using BLUETOOTH as an example, when the intelligent terminal is connected with the networking core device of the node A through the BLUETOOTH, the intelligent terminal may configure operation parameters and logic of the WiFi function module of the node E. For example, the intelligent terminal may configure connection parameters of the WiFi function module, find the SSID of the WiFi router which can be connected, and input verification information. The WiFi function module may be connected to the internet through the WiFi router.

For another example, the WiFi function module may be provided with a router function including a WAN interface for accessing a broadband. The intelligent terminal may configure a broadband access mode and information, such as PPPoE internet account number information or ADSL access, and the WiFi function module is connected to the internet. After the configuration is completed, the intelligent terminal may be disconnected from the BLUETOOTH connection with the networking core device of the node A. In other embodiments, the WiFi function module may access to the internet through other configuration methods. For example, when the first network is not established, the intelligent terminal is connected with the networking core device of the node E through BLUETOOTH to config the WiFi function module. In addition, a default setting of the WiFi function module may be enabled to automatically connect the internet after being started.

When the WiFi function module is successfully connected to the internet, any node in the first network is also connected into the internet. Further, any node in the first network may obtain information from the cloud through the WiFi function module, and receive cloud control. Specifically, when the WiFi function module successfully accesses the internet, any intelligent terminal may remotely log in the cloud server, and relevant information or functions of any node in the first network may be checked or controlled through the cloud server. The cloud server may be used as a remote server, the WiFi router or the WiFi function module.

The WiFi function module in the embodiments may also be a module with the internet access function according to other communication protocols, for example, Global System of Mobile communication (GSM), General Packet Radio Service (GPRS), Code Division Multiple Access (CDMA), Wideband Code Division Multiple Access (WCDMA), Long Term Evolution (LTE) and so on.

The intelligent network system based on the electronic module is used for establishing a network based on a first communication protocol. The function modules at different physical positions may work cooperatively, and the configuration of the function modules may be completed at one time on the intelligent terminal. If a WiFi function module is included, the system may also realize various internet applications. The intelligent network system based on the electronic module is easy to expand and configure, so that the inventive space and interestingness are created for the building of the system.

In one embodiment, the intelligent network system may include a networking core device 1, a collision sensing module, a networking core device 2, a display module and a media playing module. The networking core device 1 is connected with the collision sensing module and is placed on a door to serve as a system node 1. The display module and the media playing module are all connected to the bus of the networking core device 2, and are used as a system node 2 to be placed on a desk in a room. After completing the configuration, when the sensor of the system node 1 detects that someone pushes away the door, the networking core device 1 is in communication with the networking core device 2, and the display module may display a preset character or an image and the media playing module may play a specified ring tone.

In another embodiment, the intelligent network system may include three networking core devices, a display module, a timer module, a motor module, a media playing module and a WiFi function module. The display module, the timer module and the WiFi function module are connected with the networking core device 1 to form a system node 1, and the system node 1 is placed on a bedside table as an alarm clock. The media playing module is connected with the networking core device 2 to serve as a system node 2. The media playing module may be connected to the household audio device through an external socket, and the system node 2 is placed near the household audio device. The networking core device 3 is connected with the motor module to serve as a system node 3. The motor module may include a connecting arm, and the system node 3 may be placed near the automatic curtain, so that the connecting arm is located above a switch button of the automatic curtain.

After the system configuration is completed, when the timer module of the system node 1 reaches the set time (the alarm time set by the user), the WiFi function module is controlled to obtain audio information (weather forecast, news broadcasting, music channels and the like) from a preset website. The system node 1 transmits the obtained audio information to a system node 2, and the audio information obtained from the network is played through the media playing module and the household audio device. The system node 3 is also triggered, the motor module is started to control the connecting arm to press the switch button and restore the original position. Then the automatic curtain is opened. The timer module of the system node 1 may be synchronized with the network time through the WiFi function module.

The intelligent terminal may be a mobile phone, a tablet computer, a notebook computer, a personal computer, a workstation, a server and the like. The hardware structure of the intelligent terminal may include the processor, the memory, the external communication module, the display unit and the input unit. The intelligent terminal may be installed application programs of networking configuration. The application program may be stored in the memory, and when the processor executes the application program, the function of performing networking configuration with the user interaction may be processed.

The application program may include a connection unit and a configuration unit. The connection unit may be used for establishing connection between a networking core device or a WiFi function module. After the connection is established, the application program may obtain relevant information of all nodes in the network established based on the first communication protocol. The configuration unit may be used for viewing and configuring relevant information of the node.

For example, when a user selects one node in the network, the application program may display a topological structure of a current network on a graphical interface. The graphical interface may display the network configuration information of the networking core device of the selected node and the functional state information of the function module contained in the selected node. The user may modify the displayed information on the graphical interface, such as modifying the parameters of the networking and modifying the parameters of the function module. Further, the user may define regular logic for cooperative work of a plurality of nodes on the graphical interface.

For example, when configuring the media playing module, the user may select the audio content which needs to be played by the media playing module, and the condition for playing the audio content may be added. When adding the condition, the graphical interface may display all other functional modules in the network, and the user may select one or more function modules. The parameter of the selected function module may be used as a triggering condition for playing the audio content by using the media playing module.

In some embodiments, the intelligent terminal may further include information and guide unit. The user may understand the information of the modular construction system through the unit and achieve the purpose of educational learning demonstration. The user may query specific parameter configuration information of a certain function module supported by the modular construction system, or an application example of the function module. The information and guide unit may also include one or more sets of preset configuration information and corresponding introductions.

The user may select a required configuration according to the introduction, and the application program may automatically detect whether the hardware in the network meets the hardware requirement. If not, the application program may remind the user of missing or wrong module information. When hardware in the network meets the selected configuration requirement, configuration information is automatically sent to enable the nodes in the network to operate according to the configuration.

Alternatively, when the user selects one configuration, the application program may enter the interactive assembly tutorial interface. In the interactive assembly tutorial interface, the application program may prompt the user how to assemble the components step by step. The application program may real-time monitor whether the user has completed the current step and, if done, proceeds to the next step. For example, the current step is to connect the second networking core device to the display module. When the user completes this step, the second networking core device automatically recognizes the display module and sends the recognition result to the intelligent terminal. The application program determines that the secondary step has been completed and goes to the next step.

When the hardware installation is complete, the interactive assembly tutorial interface may be transferred to the parameter configuration tutorial interface. The user may continue to step on the intelligent terminal to complete the required functional configuration. After the configuration is completed, even if the intelligent terminal is disconnected, each node in the network may perform the corresponding function according to the configuration information.

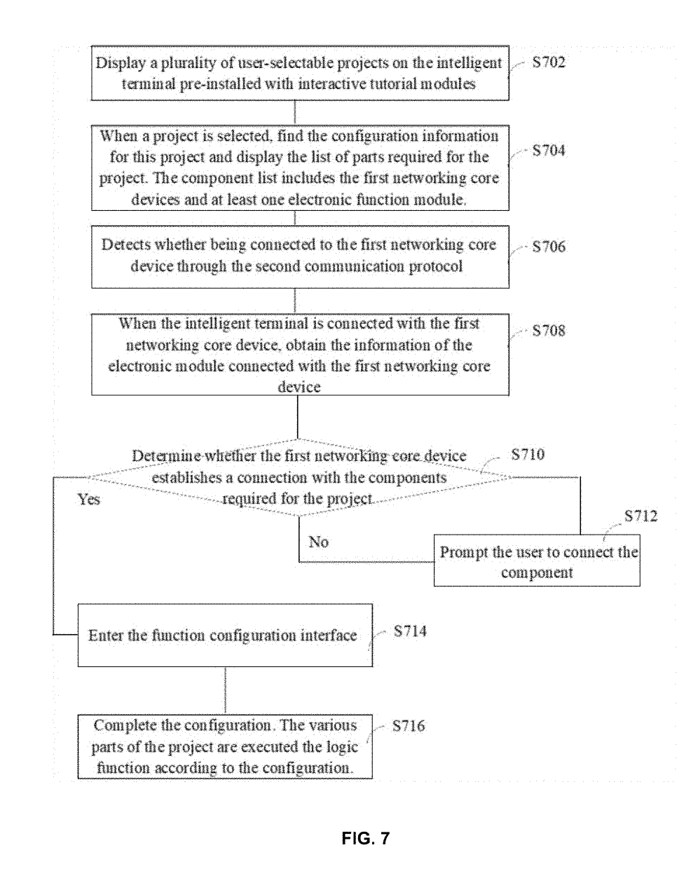

FIG. 7 illustrates a flow chart of a demonstration of an exemplary intelligent network system based on an electronic module consistent with various disclosed embodiments. As shown in FIG. 7, the user may use the intelligent terminal pre-installed with interactive tutorial modules, and the intelligent terminal may display a plurality of user-selectable projects (S702). The interactive tutorial module may be embedded in the application program of the aforementioned network configuration, or may be an application program that requires a separate installation. A separately installed application program may communicate with the network configuration application program to complete the corresponding function.

The intelligent terminal may display multiple projects of different degree of difficulty and/or different functional areas for users to choose. In some embodiments, the intelligent terminal allows the user to select a suit or component that the user already has, to search for a project that meets the criteria (i.e., a project that could be completed with the user's components) based on the user's input, and recommends that the user builds the project.

When a project is selected, the intelligent terminal may find the configuration information for this project and display the list of parts required for the project (S704). The component list includes the first networking core devices and at least one electronic function module. For example, the components required for this project may include a networking core device 1, a collision sensing module, a networking core device 2, a display module and a media playing module.

The intelligent terminal detects whether being connected to the first networking core device through the second communication protocol (S706). The specific detection and connection process may refer to the relevant description of the embodiment of FIG. 4. In some embodiments, step S706 may be completed before step S702. When the intelligent terminal is connected with the first networking core device, the intelligent terminal may obtain the information of the electronic module connected with the first networking core device (S708). The electronic module connected to the first networking core device may include: an electronic function module mounted on the bus of the first networking core device, one or more other networking core devices connected with the first networking core device via the first communication protocol, and electronic function modules mounted on the bus of other networking core devices.

Based on the obtained information of the electronic module, the intelligent terminal may determine whether the first networking core device establishes a connection with the components required for the project (S710). When it is detected that the required part is not connected, the intelligent terminal may prompt the user to connect the component (S712). For example, the user is prompted to connect the display module to the bus of the networking core device 2. In some embodiments, the intelligent terminal may also detect whether there is a component connection error, such as an electronic function module that should be connected to the first networking core device is connected to other networking core device. When a component connection error is detected, the intelligent terminal may prompt the user the error and display the correct connection.

When the intelligent terminal detects that the required part of the project is connected properly, the intelligent terminal may enter the function configuration interface (S714). The Intelligent terminal may prompt the user different effects that different configuration parameters can achieve, and recommend the user with default configuration parameters. When the configuration is completed, the various parts of the project are executed the logic function according to the configuration (S716). In addition, the prompt information presented by the intelligent terminal may be a variety of forms, including but not limited to: text, pictures, voice, animation, video and so on.

The present disclosure provides the intelligent network system based on the electronic module that is easy to expand and configure without the need of programming. The intelligent terminal may connect to any one of the network nodes, and the user may visually configure all the network nodes through the application program. Function modules of the wireless communication and work cooperation may be achieved, and the system may provide a lot of creative space and interestingness.

The electronic modules (e.g., networking core devices and functional electronic modules) of the present invention may be provided with one or more electronic chips on the PCB to form an integrated circuit board. The housing (e.g., a plastic housing) and the integrated circuit board are assembled to form an electronic module. The electronic module may further include a magnet capable of magnetically connecting the electronic module with another electronic module.

Any suitable electronic chip (or IC chip) may be preassembled or otherwise integrated into a circuit board of a corresponding module. Examples of electronic chips may include but are not limited to: microcontroller units (8-bit, 16-bit and 32-bit), ARM CPU, MIPS CPU, USB2TTL, Ethernet, RS485, USB host, 2.4 GHz wireless, 433 MHz wireless, 866 MHz wireless, 950 MHz wireless, WiFi, Bluetooth, ZigBee, Near Field Communication (NFC), Micro SD, GPS, GPRS/GSM, 4G/LTE, wireless charger, MP3 decoder, amplifiers, organic light-emitting diodes (OLEDs), motor drivers, step driver, real time clock (RTC), accelerometer, gyroscope, magnetic field strength, lithium battery manager, dual connection board, Arduino-Microduino pin conversion, skin current sensors, arsenic detectors, resistors, capacitors, inductors, and/or other chips arranged in the same or different modules for making the desired electronic modules.

Each electronic module may perform one or more individual functions (e.g., an LED, a button, a light sensor, etc.), and may combine the modules to create a larger circuit. Some modules may react to external events such as mechanical force, touch, proximity, RF signals, environmental conditions, and so on. Some other modules may be pre-programmed as function modules such as synthesizers, oscillators, and so on. There are some modules that may simply be used to transfer current, such as wire modules. Some other modules may be used to provide current, such as power blocks/power modules. The system may also include, for example, an adapter board for connecting with other electronic module building systems (electronic building blocks).

The electronic function module of the present invention may have a standardized interface and match the external port of the networking core device. When any electronic function module and the networking core device are successfully connected, the networking core device may identify and control the connected electronic function module.

The electronic modules described in the present invention may be electrically connected to each other. For example, the integrated circuit board may include electrical conductors, such as metal probes and pin connectors, for transferring current between adjacent stacked modules. The pin connector may be a spring pin to prevent damage and further extend the life time of the module.

The pin connector may include any number of spring probes of any suitable layout. The pin connector may be used as a current transfer and/or electronic communication between a module and the next module. For example, the pin connector 5 may be a spring pin such as a spring ejecting pin (or called pogo pin or pogo spring pin) for ensuring the connection between the stacking modules. In one embodiment, the pogo pin may include 27 pogo pins arranged in a U-shape, about 44 pogo pins arranged in an H-shape, or about 88 pogo pins arranged in an H-shape. Further, any other suitable means for transferring current and communication between the modules other than the spring pins should be also included within the scope of the present invention.

The electronic module-based intelligent network system may provide space for children and adults for entertainment, creation and design, and may be easily incorporated into toys and projects. In this manner, an independent module may make basic and complex products, such as sensors and/or interchangeable analog and digital circuits, with users with little or no electronic device or programming experience. The disclosed modules are reusable and may be rearranged. Either small and simple circuits or large and complex circuits may be built and implemented with the modules. The modules are also precise enough to make complex performance designs.

In addition, these modules may form a series of electronic components for creating larger, more complex components or systems. In fact, a user/player/manufacturer may almost unlimitedly add any new components to their module library. Users may even create their own modules and add them to their favorite collections.

In some embodiments, an electronic module-based intelligent network system that includes a required number of modules may be commercialized as a single set of products or a single combination. The single set of products may include one or more different modules or different types of modules, as well as containers for storing these modules, and may further include accessories, manuals, or other suitable components. A single set of products may include multiple modules designed to assemble and perform various functions in several combinations (including a single combination). A single set of products may also be designed for a particular age group, for example, a product for a primary level may include fewer and/or less complex modules than for high school level products.

Thus, different modules with different functions may form different circuits by thousands of combinations, and each component may react directly without any programming, welding, or circuit assembly. Users do not need to write any code, and may design the performance of the circuit in the intelligent terminal through the visual operation.

by manually manipulating components, as well as in the intelligent terminal on the visual operation can design the performance of the circuit.

Pre-programmed and preassembled modules may be selected in the module family to build an electronic module-based intelligent network system as a complex product prototype or circuit without programming and electronic knowledge. In addition, each module may have a different color to further distinguish each other and provide a better experience for the user.

Further, the user does not need the expertise of programming logic and circuit construction, and may use the intelligent terminal application program to complete the coordination work of multiple functional modules located in different physical positions through the interactive interface of the graphical interface.

Further, light-emitting components, sound-emitting parts, buttons and other electronic components may be added to a product or device so that the children, young students, designers, non-engineers, and others who lack the necessary experience may easily operate. For non-professionals, it would be a cost-effective way to make electronic products easily. The disclosed modules and systems may provide a platform for enhanced learning, for experimentation and for innovation.

The present invention has several positive effects. (1) the invention provides the networking core device for the electronic module, the wireless networking method and the intelligent network system based on the electronic module. Hence the users with little or no electronic device or programming experience may construct basic and complex intelligent networks. The present invention is simple to operate and easy to expand for creative space and recreations. (2) Through the intelligent network system provided by the invention, the intelligent terminal may only connect to any network node, and the user may visualize all the network nodes through the application program on the intelligent terminal. The operation is simple and efficient to make electronic devices at different physical locations working together. (3) The intelligent terminal may control all the function modules mounted on the networking core device in the network. When one of the networking core device is mounted the communication module, the user may achieve remote control, so that the Internet of things may be easier to access people's life.

Although the present invention is disclosed above with various embodiments, the present invention is not limited thereto. Anyone skilled in the art may make various changes and modifications without departing from the spirit and scope of the present invention. Therefore the scope of the present invention should be defined by the claims thereof.

What is claimed is:

1. A networking core device, comprising:
a function-module processor configured to identify and control at least one functional electronic module electrically connected to the networking core device;
an in-group networking member configured to establish a wireless connection between the networking core device and at least one other networking core device based on a first communication protocol, and after establishing the wireless connection, communicate with the at least one other networking core device, wherein the networking core device and the at least one other networking core device form a wireless network based on the first communication protocol, and each networking core device is a node of the wireless network; and
a controller configured to establish a connection between the networking core device and an intelligent terminal based on a second communication protocol, and receive and process a control signal from the intelligent terminal.

2. The networking core device according to claim 1, wherein the function-module processor is further configured to:
automatically identify the at least one functional electronic module loaded on a bus of the networking core device, assign a unique communication address to each functional electronic module, and control each functional electronic module by an adequate communication speed according to a load rate on the bus.

3. The networking core device according to claim 1, wherein the first communication protocol is a wireless personal area network protocol, and the wireless network is a mesh network.

4. The networking core device according to claim 3, wherein:
the function-module processor is further configured to acquire data information of the at least one functional electronic modules;
the in-group networking member is further configured to acquire a node information of each node of the wireless network, the node information comprises a network configuration information based on the first communication protocol of the networking core device corresponding to the node, and the data information of the functional electronic module corresponding to the node; and
the controller is further configured to send the node information of each node in the wireless network to the intelligent terminal.

5. The networking core device according to claim 4, wherein:
the control signal of the intelligent terminal comprises a control instruction for each node in the wireless network; and
the in-group networking member is further configured to send the control instruction to a corresponding node in the wireless network.

6. The networking core device according to claim 1, wherein:
the second communication protocol is used for supporting one or more of bluetooth communication, infrared communication and WiFi communication.

7. A wireless networking method, comprising:
electrically connecting a first networking device and at least one functional electronic module to form a first system;
establishing a wireless connection between the first networking core device and at least one second networking core device based on a first communication protocol to form a first network, wherein each networking core device in the first network is a node, and the first networking core device acquires a node information of each node in the first network;
connecting the first system and an intelligent terminal based on a second communication protocol;
sending, by the first system, the node information of each node in the first network to the intelligent terminal through a connection path between the intelligent terminal and the first networking core device established based on the second communication protocol;
receiving, by the first system, a control instruction of each node in the first network sent by the intelligent terminal; and
sending, by the first system, the control instruction to a corresponding node through the first network.

8. The wireless networking method according to claim 7, wherein connecting the first system and the intelligent terminal based on the second communication protocol further comprises:
connecting the first networking core device and the intelligent terminal based on the second communication protocol.

9. The wireless networking method according to claim 7, wherein:
the second communication protocol supports a WiFi communication;
the at least one functional electronic module comprises a first functional electronic module supporting the second communication protocol;
connecting the first system and the intelligent terminal based on the second communication protocol further comprises: connecting the first functional electronic module and the intelligent terminal based on the second communication protocol; and
the first functional electronic module sends the node information of each node in the first network obtained by the first networking core device to the intelligent terminal.

10. The wireless networking method according to claim 7, wherein the first communication protocol is a wireless personal area network protocol, and the first network is a mesh network.

11. The wireless networking method according to claim 7, wherein:
the control instruction comprises a node identifier and configuration information of a corresponding node; and
the configuration information of the corresponding node comprises: at least one of an operation parameter configuration information of the functional electronic module connected with the node and a networking configuration information based on the first communication protocol of the node.

12. The wireless networking method according to claim 11, wherein the control instruction further comprises an operation coordination logic of the functional electronic module connected with at least two nodes.

13. The wireless networking method according to claim 11, wherein:
the first system is disconnected from the intelligent terminal; and
each node in the first network operates according to the configuration information contained in the control instruction.

14. An intelligent network system based on an electronic module, comprising:
at least two networking core devices, and at least two functional electronic modules; wherein:
each networking core device is configured to:
identify and control the functional electronic module electrically connected to the networking core device;
establish a wireless connection between the networking core device and at least one other networking core device based on a first communication protocol to form a first network, wherein each networking core device in the first network is a node; and
acquire a node information of each node in the first network;
the at least two networking core devices comprise a first networking core device, the at least two functional electronic modules comprise a first functional electronic module, and the first networking core device is electrically connected to the first functional electronic module to form a first system;
the first system is connected to an intelligent terminal based on a second communication protocol;
the first system sends the node information of each node in the first network to the intelligent terminal through a connection path between the intelligent terminal and the first networking core device established based on the second communication protocol;
the first system receives a control instruction of each node in the first network sent by the intelligent terminal; and
the first system sends the control instruction to a corresponding node through the first network.

15. The intelligent network system according to claim 14, wherein the first networking core device and the intelligent terminal are connected based on the second communication protocol.

16. The intelligent network system according to claim 14, wherein:
the first functional electronic module supports the second communication protocol;
the first functional electronic module and the intelligent terminal are connected based on the second communication protocol; and
the first functional electronic module sends the node information of each node in the first network obtained by the first networking core device to the intelligent terminal.

17. The intelligent network system according to claim 14, wherein the first communication protocol is a wireless personal area network protocol, and the first network is a mesh network.

18. The intelligent network system according to claim 14, wherein:
the control instruction comprises a node identifier and a configuration information of a corresponding node; and
the configuration information of the corresponding node comprises: at least one of an operation parameter configuration information of the functional electronic module connected with the node and a networking configuration information based on the first communication protocol of the node.

19. The intelligent network system according to claim 18, wherein the control instruction further comprises an operation coordination logic of the functional electronic module connected with at least two nodes.

20. The intelligent network system according to claim 14, wherein the at least two functional electronic modules comprise one or more than one of a display module, a media playing module, a motor driving module, a temperature sensing module, a humidity sensing module, an illumination sensing module, an air quality sensing module, a human body sensing module, a color recognition sensing module, a proximity sensing module, a collision sensing module, an attitude sensing module, a heart rate sensing module, a gesture sensing module, an ultrasonic sensing module, a communication module, a voice acquisition module, and an image acquisition module.
